(19) United States
(12) Patent Application Publication
(10) Pub. No.: US 2014/0207914 A1
(43) Pub. Date: Jul. 24, 2014

(54) CERTIFICATION VALIDATION AND ASSOCIATED CONTENT ACCESS

(71) Applicant: Benjamin Paul Robinson, Lago Vista, TX (US)

(72) Inventor: Benjamin Paul Robinson, Lago Vista, TX (US)

(21) Appl. No.: 13/746,503

(22) Filed: Jan. 22, 2013

(51) Int. Cl. H04L 29/08

(52) U.S. Cl. CPC H04L 67/10
USPC 709/219

(57) ABSTRACT

Identifying and validating certified individuals (such as fitness trainers) to conduct a fitness program in conjunction with one or more user devices includes a request message being received at a computing device to initiate a fitness client session, the request message includes a request to share content with the computing device and identification information of the request originator. As a result, a certification request message is generated and transmitted to a certification server. A confirmation message may be received to indicate whether a valid certification is associated with the identification information included in the certification request message. A response message is transmitted to the request message indicating a confirmation of the fitness client session, and the content associated with the fitness client session may then be received.

### TECHNICAL FIELD OF THE APPLICATION

This application relates to identifying and validating certified fitness training information and, more particularly, to identifying and validating certified individuals (such as fitness trainers) to conduct a fitness program in conjunction with one or more user devices.

### BACKGROUND OF THE APPLICATION

Conventionally, fitness training includes access to training regiments, such as fitness classes, and other programs designed to help clients lose weight, gain muscle and endurance, and reach certain fitness goals. People who desire to engage in fitness training may contact a certified professional trainer, a local gym or fitness center, online fitness classes and/or pre-recorded fitness classes stored in the Cloud or on a static memory medium, such as DVD, etc.

As the number of personal fitness options continues to grow, consumers are increasingly faced with options as to whether they are engaging in the correct program, whether they are being led by certified professionals in a safe and effective manner, whether they are making proper progress, etc. The effort required to reach fitness goals is complemented by the consumer's desire to pay a fee and participate in the best program available to meet their specific goals and needs. Professional trainers (PT), fitness clients (FC), certifying agencies (CA), etc., may all desire to sell services and products to consumers in order to satisfy the user's needs. However, there are various problems and limitations ensuring proper advice is being provided. As such, frequent certification validation may be required, especially when providing fitness services via a data network.

### SUMMARY OF THE APPLICATION

The present application provides a method, apparatus and non-transitory computer readable storage medium that validates certified individuals to conduct a fitness program in conjunction with one or more user devices.

One embodiment of the present application includes a method that comprises receiving a request message at a computing device to initiate a fitness client session, the request message comprising a request to share content with the computing device and identification information of the request originator, generating a certification request message that includes at least part of the identification information received, transmitting the certification request message to a certification server, receiving a confirmation message indicating whether a valid certification is associated with the identification information included in the certification request message, transmitting a response message to the request message indicating a confirmation of the fitness client session, and receiving the content associated with the fitness client session.

Another embodiment of the present application includes an apparatus that comprises a receiver configured to receive a request message at a computing device to initiate a fitness client session, the request message comprising a request to share content with the computing device and identification information of the request originator, and a processor configured to generate a certification request message that includes at least part of the identification information received, a transmitter configured to transmit the certification request message to a certification server. The receiver is also configured to receive a confirmation message indicating whether a valid certification is associated with the identification information included in the certification request message and the transmitter is configured to transmit a response message to the request message indicating a confirmation of the fitness client session, and the receiver is configured to receive the content associated with the fitness client session.

A further embodiment of the present application includes a non-transitory computer readable storage medium configured to store instructions that when executed cause a processor to perform: receiving a request message at a computing device to initiate a fitness client session, the request message comprising a request to share content with the computing device and identification information of the request originator, generating a certification request message that includes at least part of the identification information received, transmitting the certification request message to a certification server, receiving a confirmation message indicating whether a valid certification is associated with the identification information included in the certification request message, transmitting a response message to the request message indicating a confirmation of the fitness client session, and receiving the content associated with the fitness client session.

### BRIEF DESCRIPTION OF THE DRAWINGS

FIG. 1 illustrates an example flow diagram of validating certifications and notifications to permit fitness content sharing according to embodiments of the present application.

FIG. 2 illustrates an example logic diagram of providing a certification procedure for uploaded video content according to embodiments of the present application.

FIG. 3 illustrates an example system diagram of a user operating a mobile computing device and participating in a fitness program managed by remote server operations according to embodiments of the present application.

FIG. 4 illustrates a flow diagram of an example method according to an example embodiment of the present application.

FIG. 5 illustrates a system that is configured to perform one or more operations according to embodiments of the present application.

FIG. 6 illustrates an example network entity device configured to store instructions, software, and corresponding hardware to perform one or more operations according to embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments, a personal trainer (PT) may be registered with a fitness service database to include certain details of his or her services. For example, the trainer may upload information that describes his or her services to a database which may be accessed by a certification application or other entity to locate the trainer, the services offered, price(s) for the services, time(s) the services are offered, current certifications and other information. Examples of such information may include demographic information (coverage area), area(s) of expertise (e.g., bodybuilding, fitness, sports, Yoga, etc.), pricing (e.g., per-hour, daily, monthly, discounts, etc.), geographical focus areas, other skills and specializations (e.g., nutrition, degrees, etc.), certification numbers (e.g., associations, local, state, federal, etc.), certifying agencies, payment information, products/merchandise, photo uploads, resume, etc.

A fitness client (FC) registration of a potential client seeking access to fitness resources may include client demographic information, goals, objectives, interests, non-interests, personal information (e.g., age, weight, health status, chronic conditions, body mass, blood pressure, nutritional restrictions, credit card information, billing information, etc.). A gym or fitness providing entity, association (GA) or organization registration may include a certain demographic area of coverage, personal trainer profiles (e.g., names, certification numbers, certification agencies, skills, etc.), payment information, products, merchandise, pricing, amenities and equipment.

According to example embodiments, a user operating a user computing device may utilize a software application that maintains a current status of a user while participating in a live physical training session or other fitness program. According to one example, a user may be participating in an online or teleconferencing aerobics session and may be viewing an instructor or classroom from his or her computing device. In this example, the user may receive positive or negative feedback depending on the instructor's ability to view the user and provide feedback via an automated session monitoring function that monitors a user's activity, such as a number of pedometer steps, heart rate, pace, distance, other vital signs etc., and provide that information as feedback to the present session log file to determine whether the user is off-beat, ahead of pace, behind pace, etc.

The system may log a particular goal in the log file of a particular user profile, such as a target heart beats per minute for an aerobic session, which may be used as a baseline to measure a present user status and provide feedback if necessary. The user performance information may be provided by a wired or wireless interface with a user's computing device. The information may include heart rate, pulse, blood pressure, steps, movement vectors (using a gyroscope, for example), etc.

According to one example method of operation, a user my set a particular goal (e.g., ‘X’ calories per session, target heart rate, time frame ‘Y’, etc.) and enter the data into their personal record stored in a data fitness file, and then can input various other personal user parameters, such as age, weight, intensity desired, fitness level, etc. Before selecting a workout session, the user may have his or her user input parameters analyzed and applied to a particular registered workout game plan and/or routine. For example, a certified fitness routine may be established and stored in memory and applied to a user depending on his or her goals and/or personal data. One example, may include a known fitness routine, such as ZUMBA®, BODYPUMP®, etc., being selected and applied to a user's profile at a certain intensity level, such as beginner, medium, advanced, and expert. The intensity of the live instructor, the pre-recorded video or any other content source may be identified and applied to the user's current plan depending on the user's input information and/or preferences.

Content or videos that are pre-recorded may have particular metatags, such as name brand workouts, for example, ‘ZUMBA®’, and may also include other information, such as intensity levels, such as ‘moderate’ that are identified and linked to a user's profile based on the user's desired or computer determined parameters. In operation, if a user is a beginner and receives a beginner level aerobics class as part of a weekly routine schedule, the user may have the option to select an instructor that teaches the ‘beginner’ class or the system may select the instructor automatically based on the user's mobile computing device location (e.g., GPS, city, etc.) or known trainer preferences of the user (e.g., female/male instructor, ethnicity/language spoken by instructor, age range of instructor, etc.).

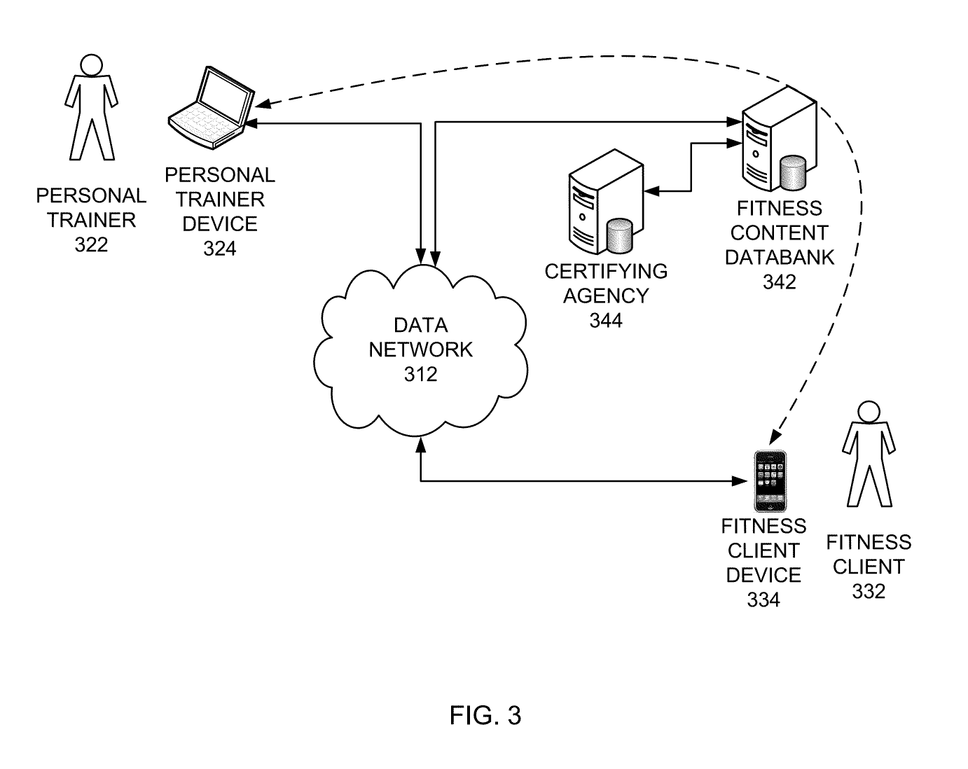

The user computing device may be a computer, laptop, mobile, wireless or cellular phone, a PDA, a tablet, a client a server or any device that contains a processor and/or memory, whether that processor or memory performs a function related to an embodiment of the application. In the example network configuration of FIG. 3, the user is operating a smartphone and the fitness instructor is utilizing a laptop to stream the workout to the end user, however, any variation of computing, wired device(s) and/or wireless device(s) may be operated by the users to share audio, video, text and other data (such as an analysis of the session) related to the fitness program.

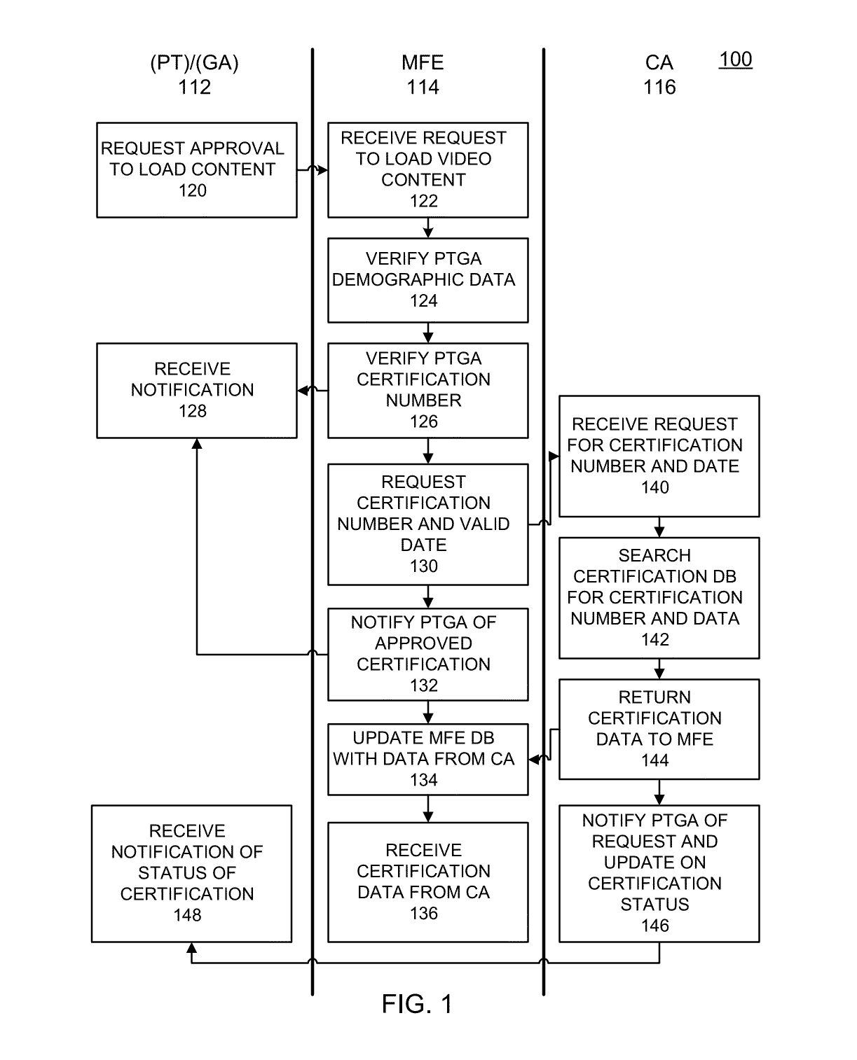

FIG. 1 illustrates an example data and logic flow diagram of communication operations performed between various communication and computing devices of a personal trainer/gym association (PT)/(GA), a mobile fitness entity (MFE) of the user/fitness client and a certifying agency (CA) that maintains professional certification and other data of the various trainers and other personnel.

Referring to FIG. 1, a process 100 may initiate with the PT or GA 112 retrieving a video or other content to provide to the end user of the mobile fitness application 114. The PT device may request to load certain content (i.e., a live aerobics session, a pre-recorded session, etc.) to the end user device of the MFE 114. The user device 114 may receive the request and load the content 122 on the user's device so the user may engage in a fitness record, aerobics video, etc. Next, the user's requirements and predetermined criteria, such as name brand classes, certified trainers, trainer profiles, etc., may be observed and retrieved from a user's fitness data file record to determine whether the user has required the trainer to be among a particular local demographic 124 and/or a certified trainer 126. If so, the PT/GA must be certified and match the requirements of the user's data file by verifying an address and observing a radius requirement and verifying that a certification number is included in the PT/GA record. The PT/GA 112 may then receive a notification 128 that the user application has accepted or rejected the content loading initiation operation 120 depending on the results of the certification.

Continuing with the example method of operation in FIG. 1, the MFE 114 may utilize the fitness application to request the certification number and a valid date 130. The record management server or certifying agency (CA) 116 may then receive the request for the certification number and date at operation 140 and determine whether the PT/GA 112 is certified in a process that operates parallel to the MFE content certification procedure in FIG. 1. The MFE device 114 may continue by notifying the PT/GA 112 that an approved certification 132 exists so the MFE database will be updated 134 with the certification data from the CA 116, and the corresponding certification data will be received from the CA 136. The PT/GA 112 may receive the notification status of the certification 148 and whether it exists or is invalid or outdated. The CA 116 will verify its information by receiving a request for a certification number and date 140 and search its database for such information 142. The results may be returned 144 to the MFE 114 and optionally transmitted to the PT/GA 112 in a notification message 146.

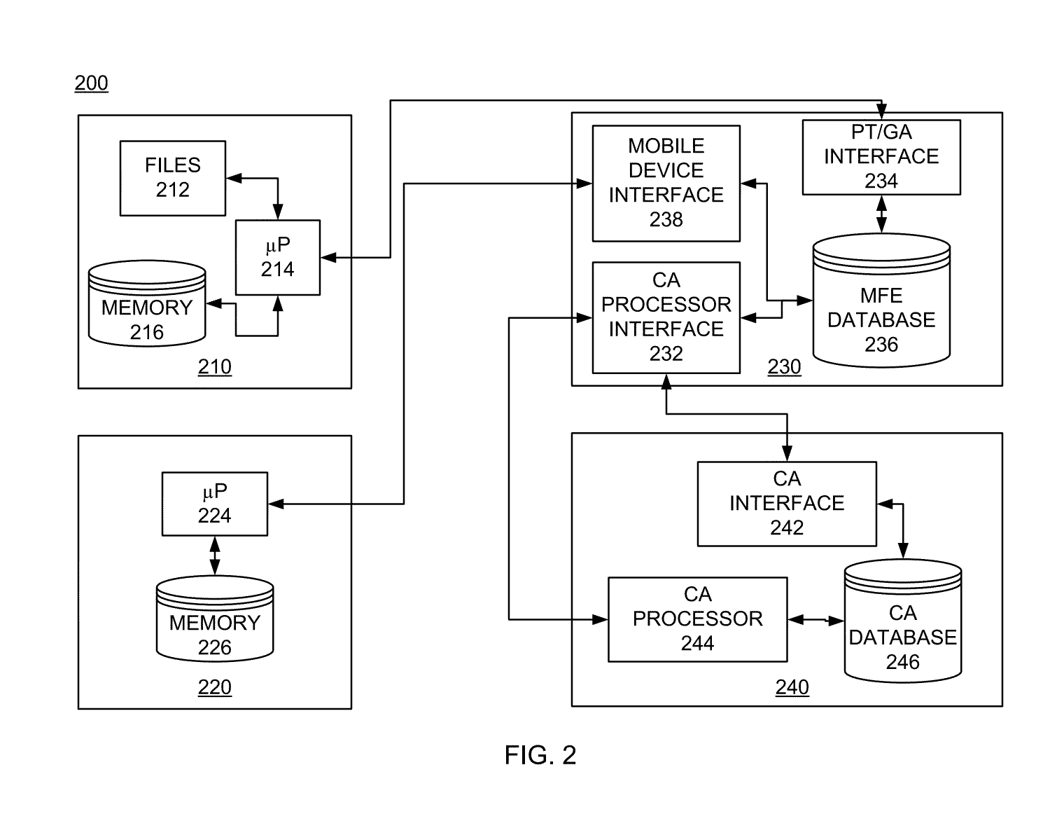

FIG. 2 illustrates an example logic diagram of the various communicating entities communicating across a data network to provide fitness credentials, content and other fitness application data. Referring to FIG. 2, the system network 200 includes a PT/GA computing device 210, a PT mobile computing device 220, a MFE communication device of the fitness client 230 and a certifying agency (CA) communication device of a third party certification institution 240.

In operation, the PT/GA computing device 210 may transmit a request to the MFE computing device 230 to load certain content for commercial use by fitness clients. The PT/GA computing device 210 may include one or more data content files 212, which are recorded and uploaded for commercial purposes. Examples may include fitness classes recorded by a particular trainer or at a particular gym association. The content may be retrieved from memory 216 and retrieved via a processor 214. The content selections may be identified by their titles and a request may be generated to upload those titles to the MFE device 230. In response, the MFE 230 may receive the request at the PT/GA interface 234 and begin the authorization and credentialing process.

The MFE device 230 may generate a request in response to receiving the request from the PT/GA device 234 and submit a request to the CA device 240 via the CA processor interface 232. In response, the CA interface 242 receives the request and the CA processor 244 will execute a query to the CA database 246 based on the information provided by the MFE device 230, such as a PT/GA name, address, date, certification name, number, etc. The information is included in the query and is submitted to the database 246 for reference purposes. The results of the query may be then transmitted from the CA device 240 to the PT/GA device 230 via the CA processor interface 232. If the certification(s) is valid, the MFE may then accept a content request from the PT device 220 via the mobile device interface 238, which executes a request from its processor 224 which utilizes a memory 226 to identify the PT information, content titles, or other information necessary for the MFE 230 to identify and authorize the PT 220 to begin a workout session or other live or pre-recorded content sharing session.

FIG. 3 illustrates an example communication network device configuration according to example embodiments. Referring to FIG. 3, the personal trainer 322 may be operating a laptop 324 or other portable communication device 324 which is capable of providing the trainer with an access portal, a content sharing portal or other operations useful for communicating and sharing data with the fitness client 332. The personal trainer may initiate a content sharing session request by transmitting a request to the fitness client device 334 to share content. As a result, the application operating on the client's mobile device 334 may automatically contact a cloud based content sharing database 342 to retrieve a popular pre-recorded data title, such as aerobics lesson #1 or other fitness content to download and view for fitness related purposes. The fitness content databank 342 may be awaiting an authorization from the certifying agency 344 to confirm the trainer is certified and part of the fitness client 332 network of registered users. The data network 312 may be the Internet or other large-scale communication network that supports message handling, IP address packets and related information necessary to share data. Once the personal trainer device 324 receives its authorization, the fitness content databank 342 may offer pre-recorded or live data feeds from the personal trainer device 324 that are streamed to the fitness client device 334.

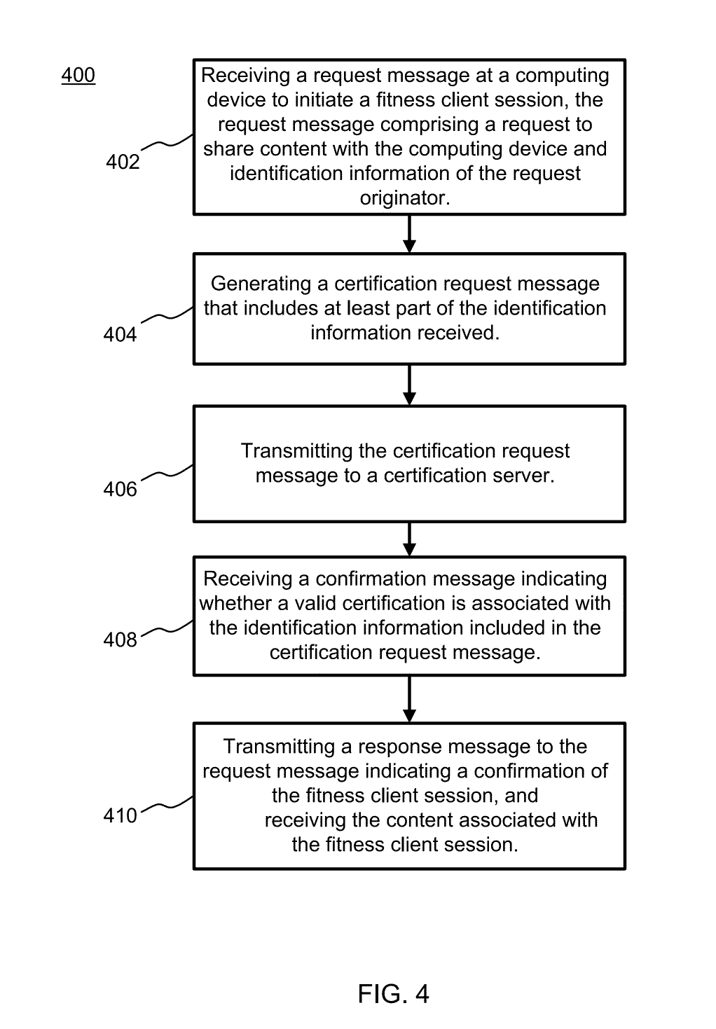

FIG. 4 illustrates an example method of operation 400. Referring to FIG. 4, this example method may include receiving a request message at a computing device to initiate a fitness client session, the request message comprising a request to share content with the computing device and identification information of the request originator, at operation 402. The method may also include generating a certification request message that includes at least part of the identification information received, at operation 404. The method may further include transmitting the certification request message to a certification server, at operation 406 and receiving a confirmation message indicating whether a valid certification is associated with the identification information included in the certification request message, at operation 408. The method may also include transmitting a response message to the request message indicating a confirmation of the fitness client session, and receiving the content associated with the fitness client session, at operation 410.

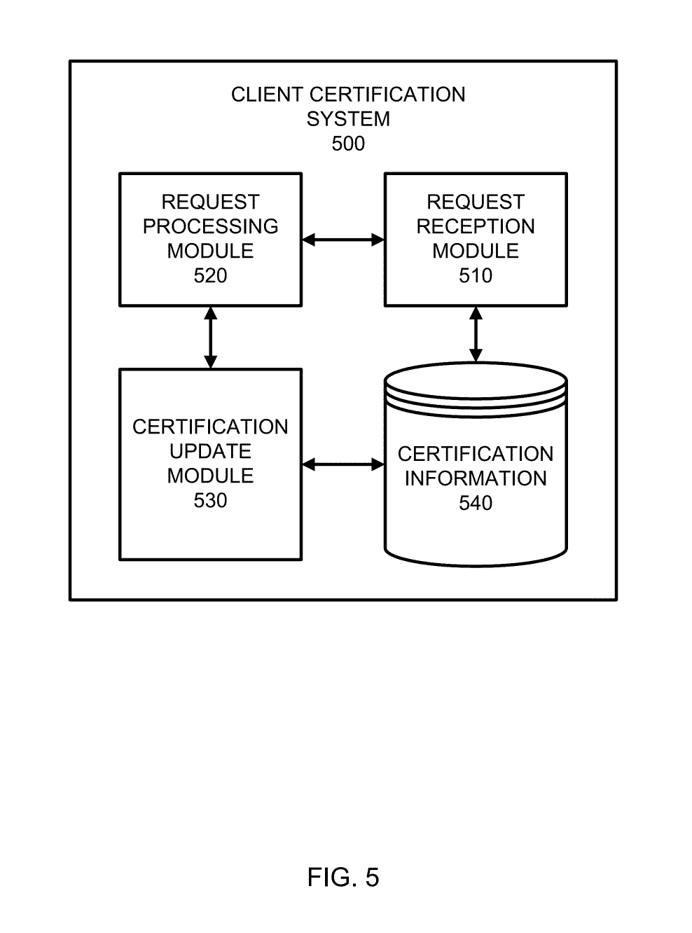

FIG. 5 illustrates an example fitness client certification system 500 according to example embodiments. Referring to FIG. 5, the client certification system 500 may include a request reception module 510 which receives and processes the requests received from trainers, gym associations or other entities seeking access to fitness client accounts or end user devices. One example method of operation performed by the certification system 500 may include receiving a request message at the request reception module 510 to initiate a fitness client session. The request message may include a request to share content with a computing device of a fitness client. The request may also include various identification information of the request originator (i.e., the personal trainer, gym association, etc.).

In response to receiving the request, the system may generate a certification request message via the request processing module 520 that includes at least part of the identification information received, such as the trainer identifier, credentials, etc. The certification request message may be transmitted to a certification entity, such as a remote server to be authenticated based on the information received from the personal trainer. In response, a confirmation message may be received and the certification update module may determine whether a valid certification is associated with the identification information included in the certification request message. The certification update module 530 may then update the certification information database 540 to include the updated certification information, such as valid credentials associated with a particular trainer or gym association, or non-valid credentials depending on the result of the credential association. As a result, a response message may be transmitted in response to the request message indicating a confirmation of the fitness client session. If the certification information is valid and updated, the fitness client may then receive the content associated with the fitness client session.

The identification information may include a personal trainer profile that includes at least one of a gym association affiliation, a certification identifier, a skill set identification, name, and contact information of the personal trainer or gym association. The content may include media content of at least one of a pre-recorded fitness session and a live fitness session or other content specified by the trainer, such as an educational audio feed or video.

According to another example, a human health monitoring sensor function may be used by the fitness client to measure a human heart beat or other vital signs to monitor feedback from a human health monitoring sensor that is attached to the human user and is linked to his or her computing device via a wired or wireless connection. The computing device may receive periodic feedback signals from the human health monitoring sensor indicating a periodic human health condition. The periodic feedback signals may be confirmed to be in compliance with at least one predetermined target threshold for a user profile associated with a user of the human health monitoring sensor. For example, a particular user may have a particular target pulse range depending on level of skill, age, etc. Also, the user may have other variables that should be taken into consideration and measured to provide an intensity level of content distributed to the user.

The periodic human health condition may be at least one of blood pressure, heart rate, heart patterns, blood sugar, and breathing patterns among other vital signs. Also, the human health monitoring sensor may include a plurality of human health monitoring sensors configured to measure a corresponding plurality of human health conditions and vital signs. The user computing device may receive a positive feedback message indicating that the periodic feedback signals have exceeded the at least one predetermined target threshold (e.g., 120 beats per minute) and a negative feedback message that the periodic feedback signals have not exceeded the at least one predetermined target threshold (e.g., below the target pulse range).

The operations of a method or algorithm described in connection with the embodiments disclosed herein may be embodied directly in hardware, in a computer program executed by a processor, or in a combination of the two. A computer program may be embodied on a non-transitory computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

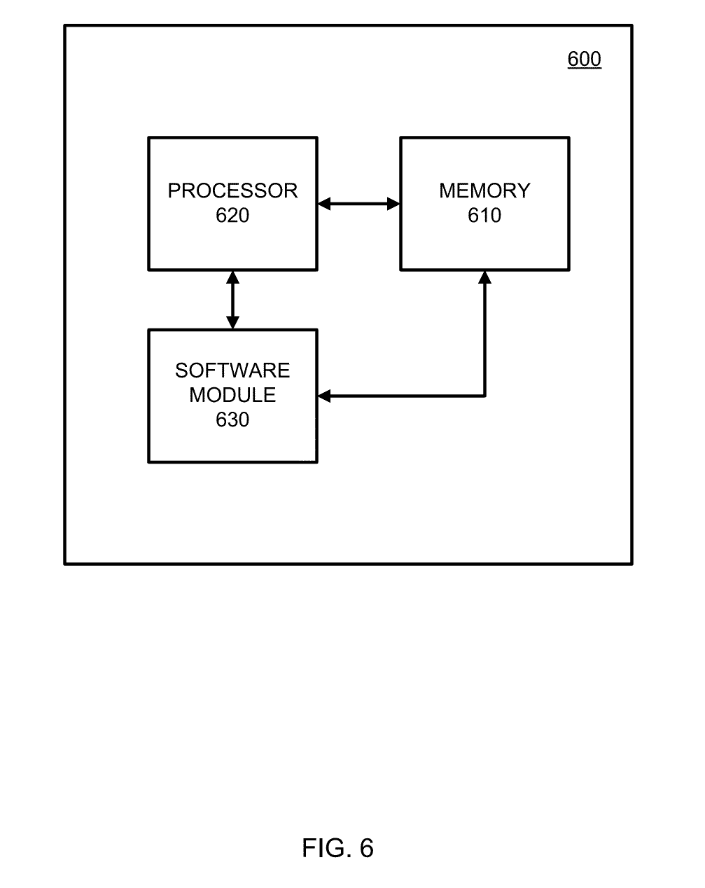

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components of FIGS. 1-3, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although exemplary embodiments of the method, apparatus and non-transitory computer readable storage medium of the present application have been illustrated in the accompanied drawings and described in the foregoing description, it will be understood that the application is not limited to the embodiments disclosed, but is capable of numerous rearrangements, modifications, and substitutions without departing from the spirit or scope of the application as set forth and defined by the following claims. For example, the capabilities of the systems of FIGS. 1, 2, 3 and 5 can be performed by one or more of the modules or components described herein or in a distributed architecture and may include a transmitter, a receiver or a pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving a request message at a computing device to initiate a fitness client session, the request message comprising a request to share content with the computing device and identification information of the request originator;
generating a certification request message that includes at least part of the identification information received;
transmitting the certification request message to a certification server;
receiving a confirmation message indicating whether a valid certification is associated with the identification information included in the certification request message;
transmitting a response message to the request message indicating a confirmation of the fitness client session; and
receiving the content associated with the fitness client session.

2. The method of claim 1, wherein the identification information comprises a personal trainer profile comprising at least one of a gym association affiliation, a certification identifier, a skill set identification, name, and contact information of the personal trainer.

3. The method of claim 1, wherein the content comprises media content of at least one of a pre-recorded fitness session and a live fitness session.

4. The method of claim 1, further comprising:
initiating a human health monitoring sensor function to monitor feedback from a human health monitoring sensor;
receiving periodic feedback signals from the human health monitoring sensor indicating a periodic human health condition; and
confirming whether the periodic feedback signals are in compliance with at least one predetermined target threshold for a user profile associated with a user of the human health monitoring sensor.

5. The method of claim 4, wherein the periodic human health condition is at least one of blood pressure, heart rate, heart patterns, blood sugar, and breathing patterns.

6. The method of claim 4, wherein the human health monitoring sensor comprises a plurality of human health monitoring sensors configured to measure a corresponding plurality of human health conditions.

7. The method of claim 4, further comprising:
receiving at least one of a positive feedback message indicating that the periodic feedback signals have exceeded the at least one predetermined target threshold and a negative feedback message that the periodic feedback signals have not exceeded the at least one predetermined target threshold.

8. An apparatus, comprising:
a receiver configured to receive a request message at a computing device to initiate a fitness client session, the request message comprising a request to share content with the computing device and identification information of the request originator;
a processor configured to generate a certification request message that includes at least part of the identification information received;
a transmitter configured to transmit the certification request message to a certification server;
wherein the receiver is also configured to receive a confirmation message indicating whether a valid certification is associated with the identification information included in the certification request message and the transmitter is configured to transmit a response message to the request message indicating a confirmation of the fitness client session, and the receiver is configured to receive the content associated with the fitness client session.

9. The apparatus of claim 8, wherein the identification information comprises a personal trainer profile comprising at least one of a gym association affiliation, a certification identifier, a skill set identification, name, and contact information of the personal trainer.

10. The apparatus of claim 8, wherein the content comprises media content of at least one of a pre-recorded fitness session and a live fitness session.

11. The apparatus of claim 8, wherein the processor is further configured to initiate a human health monitoring sensor function to monitor feedback from a human health monitoring sensor, and the receiver is configured to receive periodic feedback signals from the human health monitoring sensor indicating a periodic human health condition, and confirm whether the periodic feedback signals are in compliance with at least one predetermined target threshold for a user profile associated with a user of the human health monitoring sensor.

12. The apparatus of claim 11, wherein the periodic human health condition is at least one of blood pressure, heart rate, heart patterns, blood sugar, and breathing patterns.

13. The apparatus of claim 11, wherein the human health monitoring sensor comprises a plurality of human health monitoring sensors configured to measure a corresponding plurality of human health conditions.

14. The apparatus of claim 11, wherein the receiver is configured to receive at least one of a positive feedback message indicating that the periodic feedback signals have exceeded the at least one predetermined target threshold and a negative feedback message that the periodic feedback signals have not exceeded the at least one predetermined target threshold.

15. A non-transitory computer readable storage medium configured to store instructions that when executed cause a processor to perform:
receiving a request message at a computing device to initiate a fitness client session, the request message comprising a request to share content with the computing device and identification information of the request originator;
generating a certification request message that includes at least part of the identification information received;
transmitting the certification request message to a certification server;
receiving a confirmation message indicating whether a valid certification is associated with the identification information included in the certification request message;
transmitting a response message to the request message indicating a confirmation of the fitness client session; and
receiving the content associated with the fitness client session.

16. The non-transitory computer readable storage medium of claim 15, wherein the identification information comprises a personal trainer profile comprising at least one of a gym association affiliation, a certification identifier, a skill set identification, name, and contact information of the personal trainer.

17. The non-transitory computer readable storage medium of claim 15, wherein the content comprises media content of at least one of a pre-recorded fitness session and a live fitness session.

18. The non-transitory computer readable storage medium of claim 15, wherein the processor is further configured to perform:
initiating a human health monitoring sensor function to monitor feedback from a human health monitoring sensor;
receiving periodic feedback signals from the human health monitoring sensor indicating a periodic human health condition; and
confirming whether the periodic feedback signals are in compliance with at least one predetermined target threshold for a user profile associated with a user of the human health monitoring sensor.

19. The non-transitory computer readable storage medium of claim 18, wherein the periodic human health condition is at least one of blood pressure, heart rate, heart patterns, blood sugar, and breathing patterns.

20. The non-transitory computer readable storage medium of claim 18, wherein the human health monitoring sensor comprises a plurality of human health monitoring sensors configured to measure a corresponding plurality of human health conditions, and the processor is further configured to perform receiving at least one of a positive feedback message indicating that the periodic feedback signals have exceeded the at least one predetermined target threshold and a negative feedback message that the periodic feedback signals have not exceeded the at least one predetermined target threshold.
